(19) United States
(12) Patent Application Publication
(10) Pub. No.: US 2016/0260180 A1
(43) Pub. Date: Sep. 8, 2016

(54) PARAMETER MEASUREMENT REFINEMENT IN OIL EXPLORATION OPERATIONS

(71) Applicant: LANDMARK GRAPHICS CORPORATION, Houston, TX (US)

(72) Inventors: Christina Vasquez, Houston, TX (US); Maurice Gehin, Houston, TX (US)

(21) Appl. No.: 14/431,177

(22) PCT Filed: Apr. 9, 2014
(86) PCT No.: PCT/US2014/033481

§ 371 Date: Mar. 25, 2015

(51) Int. Cl. G06Q 50/02; G06Q 10/06; E21B 41/00

(52) U.S. Cl. CPC G06Q 50/02; E21B 41/0092; G06Q 10/06316

(57) ABSTRACT

In some embodiments, an apparatus and a system, as well as a method and an article, may operate to access a workflow database, the workflow database including operations data describing workflow operations for performing an oil recovery process and the workflow database having result data indicating a result of the oil recovery process; to generate a list that includes a plurality of parameters related to the workflow operations; to determine predicted impacts, on the result, of changing values for the plurality of parameters; to select a parameter of the plurality of parameters that has a largest predicted impact on the result relative to the predicted impacts of non-selected ones of the plurality of parameters, to provide a selected parameter; and to provide a recommendation for refinement of measurement data related to the selected parameter. Additional apparatus, systems, and methods are disclosed.

### BACKGROUND

Understanding the structure and properties of geological formations is important for a wide variety of applications in well exploration and drilling. To aid in this understanding, operators may make measurements of a multiplicity of parameters.

It can be difficult or costly to drill exploration wells to capture these measurements. Ongoing efforts are directed to helping operators use their measurement-capturing resources in an economical and effective manner.

### BRIEF DESCRIPTION OF THE DRAWINGS

FIG. 1 is a flowchart illustrating a method for providing a recommendation for refinement of measurement data related to measured parameters in accordance with some embodiments.

FIG. 2 illustrates a graphical user interface (GUI) screen for viewing and selecting workflows in accordance with some embodiments.

FIG. 3 illustrates an example GUI screen for selecting parameters to monitor in a sensitivity analysis in accordance with some embodiments.

FIG. 4 illustrates an example GUI screen for selecting options for sensitivity analysis in accordance with some embodiments.

FIG. 5 illustrates an example GUI screen for selecting sensitivity analysis output options in accordance with some embodiments.

FIG. 6 is a block diagram of a computer system for implementing some embodiments.

### DETAILED DESCRIPTION

To address some of the challenges described above, as well as others, apparatus, systems, and methods are described herein to help operators plan for more effective usage of exploration resources. Some available systems for oil and gas drilling and exploration provide software suites or other tools that allow operators to assemble workflows to perform various measurements or other operations related to drilling and exploration processes. These workflows often rely on large numbers of measurements. Many of these measurements may relate to parameters that have little to no effect on workflows or results of workflows.

Some embodiments allow operators to determine which parameter or set of parameters has the largest effect on workflows. Operators can view lists of parameters that have been restricted to a subset of available parameters, based on various criteria including selection states or operational states of sub-processes in the workflows. Operators can allocate drilling and exploration resources to refine measurements of some of those parameters to ensure that the most accurate measurements of some parameters are captured. On the other hand, operators can choose to spend little or no time and resources capturing measurements for other parameters that have little or no effect on workflows.

Users in various departments or groups of an operator's organization can provide inputs or data to workflow operations, through uploads or electronic communications, for example. Systems and apparatuses in accordance with some embodiments can receive input data corresponding to a multiplicity of parameters. Systems and apparatuses in accordance with some embodiments can receive input data from oil and gas drilling and exploration tools, from user inputs, from remote memory, or from other memory, for example. Embodiments can then execute sensitivity analysis to determine which parameters have greater effects on final outputs, or on intermediate results. Embodiments can also execute uncertainty analysis to determine best and worst-case scenarios based on uncertainty ranges of parameters.

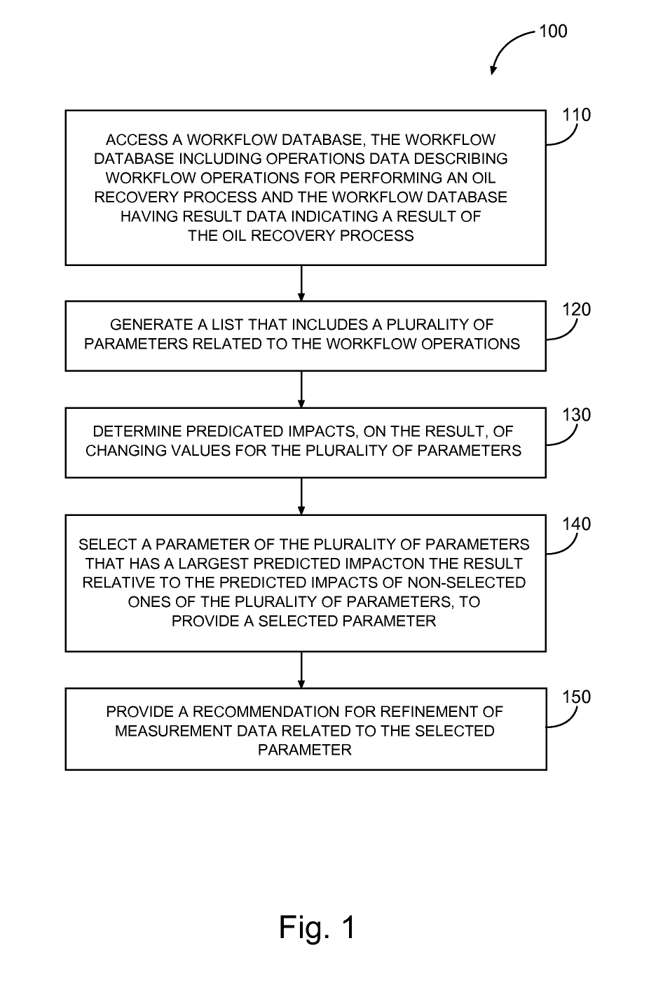

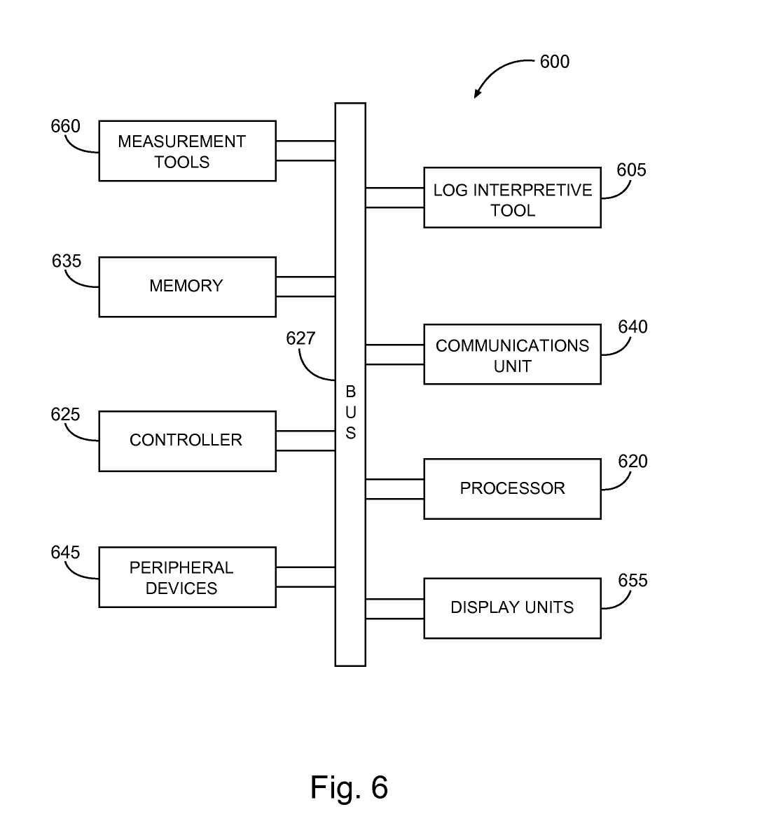

FIG. 1 is a flowchart illustrating a method 100 for providing a recommendation for refinement of measurement data related to measured parameters in accordance with some embodiments. A processor 620 (FIG. 6), other component of system 600 (FIG. 6), or another system can perform operations of the method 100. Refinement, in accordance with some embodiments, can include transforming at least one measurement representing a physical parameter associated with formation exploration operations from a less accurate measurement to a more accurate measurement.

The example method 100 starts at block 110 with accessing a workflow database. The workflow database can include operations data describing workflow operations for performing an oil and gas recovery or exploration process, including any computer-implemented processes for oil and gas exploration and recovery. The workflow database can include result data indicating a result of the oil recovery process.

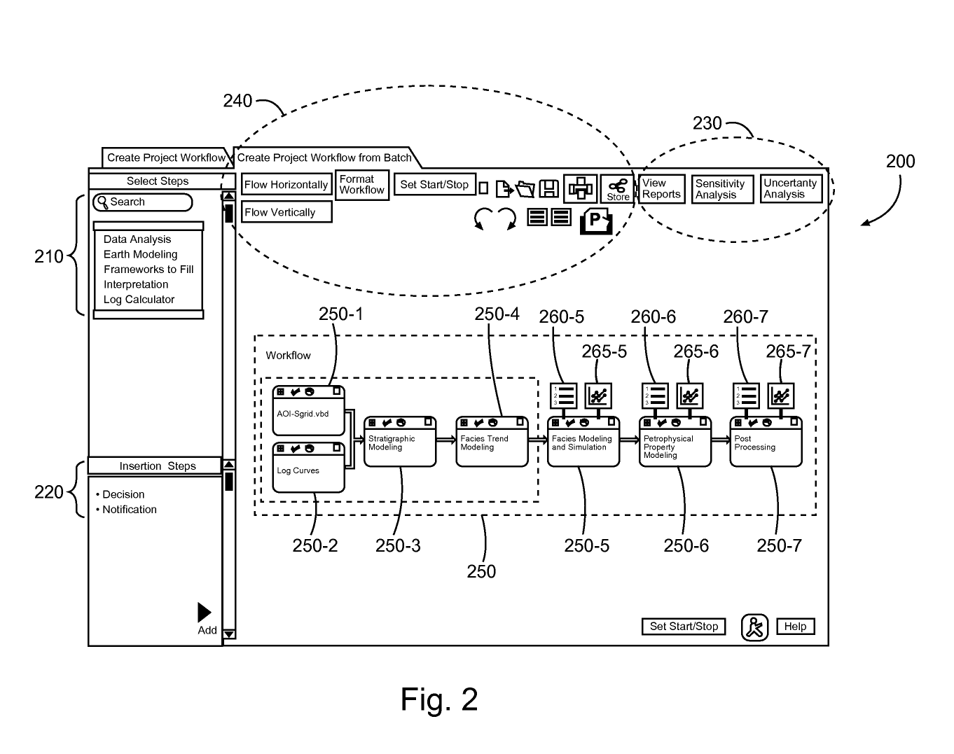

FIG. 2 illustrates a graphical user interface (GUI) screen 200 for viewing and selecting workflows in accordance with some embodiments. The GUI screen 200 can be generated by a processor 620 (FIG. 6) and displayed on display units 655 (FIG. 6) although embodiments are not limited thereto.

The GUI screen 200 can include options for allowing an operator to create and store new workflows to the workflow database, as well as to open existing workflows from the workflow database for viewing. The GUI screen 200 may include a list 210 with operations that an operator can add to a workflow. These operations can correspond to various oil and gas drilling and exploration operations understood by those of ordinary skill in the art, for example operations related to data analysis, earth modeling, frameworks to fill, interpretation, or log calculators, although embodiments are not limited thereto. Data analysis can include operations such as chart creation, plot creation, determination of outliers in data, or determination of bad data, although embodiments are not limited thereto. Earth modeling and frameworks to fill can include operations such as generation or analysis of boundaries in layers, determining locations of invasions, determining locations of faults, determining relative movement of layers, or determining formation structure information, for example, although embodiments are not limited thereto.

The GUI screen 200 can include a list of insertion steps 220. The insertion steps 220 can include decision steps or notification steps, although embodiments are not limited thereto. Decision steps can be placed at points in the workflow at which operators shall make decisions. Notification steps can be placed at points in the workflow at which operators are to be notified of various results or conditions, for example.

The GUI screen 200 can include user interface components 230 for operators to view reports generated by or related to workflows, to perform sensitivity analysis of workflows to various parameters, or to perform uncertainty analysis, although embodiments are not limited thereto.

The GUI screen 200 can include other options 240 to allow operators to configure the GUI screen 200 into a desirable configuration, or to perform other operations such as printing, saving, or exporting, although embodiments are not limited thereto. Options 240 can include an option to open saved workflows stored in a database or other memory on an operator system 600 (FIG. 6).

The GUI screen 200 can include one or more views of a workflow 250. As described herein, a workflow can include various operations, for example log curve generation, stratigraphic modeling, facies trend modeling, facies modeling and simulation, petrophysical modeling, post processing or other operations related to the list 210 or to other oil and gas drilling and exploration operations.

The processor 620 can provide indications of portions of workflows for which the processor 620 will not execute sensitivity analysis or uncertainty analysis. For example, in FIG. 2, four operations 250-1, 250-2, 250-3, and 250-4 may be disabled, or “grayed out” to indicate that sensitivity analysis or uncertainty analysis cannot be performed and for which operators are inhibited from viewing or selecting parameters as described herein. However, embodiments are not limited to any particular number or percentage of operations being enabled or disabled, and all operations may be enabled to allow operators to view or select parameters related to corresponding operations.

Referring again to FIG. 1, the example method 100 continues at block 120 with generating lists 260-5, 260-6, 260-7, 265-5, 265-6, and 265-7 (FIG. 2) that include a plurality of parameters related to the workflow operations. The processor 620 can populate the lists 260-5, 260-6, 260-7, 265-5, 265-6, and 265-7 based on the properties of the corresponding workflow operation, on whether certain other parameters have been included in the lists 260-5, 260-6, 260-7, 265-5, 265-6, and 265-7, or on criteria such as whether a particular parameter has an effect on the operation or on subsequent operations. However, embodiments are not limited to any particular number of parameters that can be included in lists 26-5, 260-6, 260-7, 265-5, 265-6 and 265-7.

The processor 620 can also receive a request to provide a visual display of values of a parameter in addition to parameters related to the workflow operation. The processor 620 can generate this visual display on, for example, display units 655. For example, an operator may wish to view productivity analysis or other data that is unrelated to or unaffected by sensitivity or uncertainty analysis. The processor 620 can receive a request to provide productivity analysis, the processor 620 can compute this productivity analysis, and the processor 620 can thereafter display results of productivity analysis.

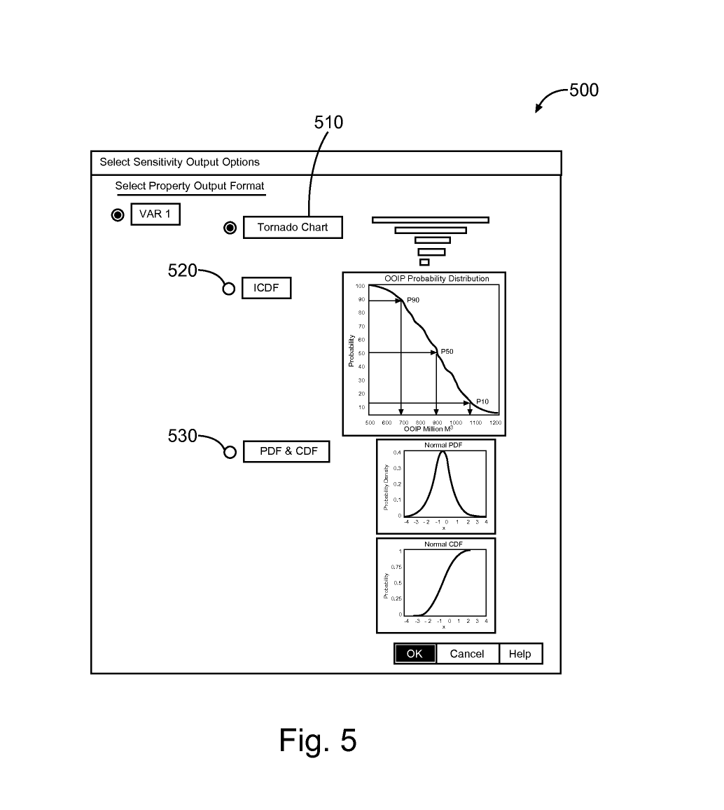

An operator can select parameters from lists 260-5, 260-6 or 260-7, for example, for further modification or analysis. Selection from lists 265-5, 265-6 and 265-7 can open a GUI screen such as, for example the GUI screen of FIG. 5 described herein. The operator can request a sensitivity analysis to analyze how much impact changing a selected parameter will have on the end result of a workflow, or the operator can request uncertainty analysis as described herein.

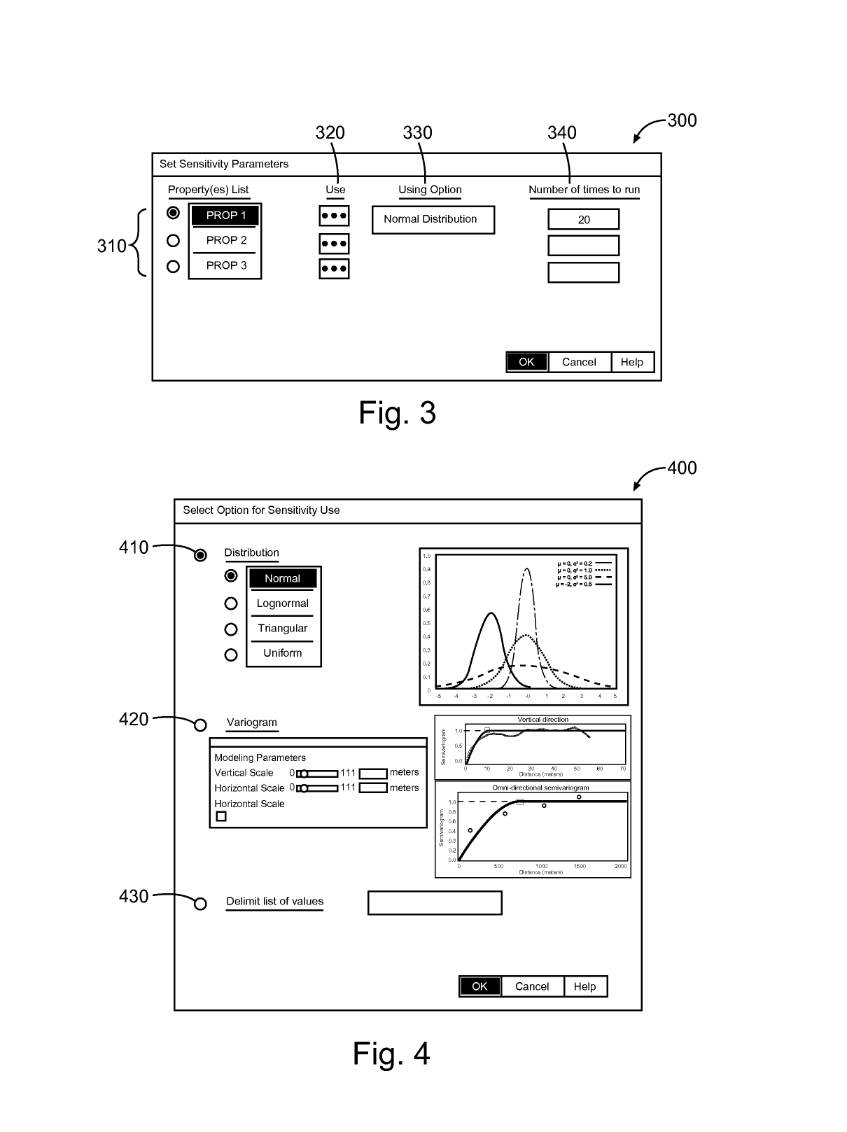

FIG. 3 illustrates an example GUI screen 300 for user selection of parameters to be monitored in a sensitivity analysis in accordance with some embodiments. However, in some embodiments the processor 620 can select the parameters to be monitored in a sensitivity analysis. The processor 620 can generate a same or similar screen can for allowing users to select parameters to monitor in an uncertainty analysis, or the processor 620 can select parameters to be monitored in the uncertainty analysis. Parameters related to workflow operations, for example parameters listed in lists 260-5, 260-6, 260-7 (FIG. 2) can be selected in list 310. However, embodiments are not limited thereto and operators can select other parameters, in addition to those related to workflow operations, for further analysis or display.

Operators can select Item 320 to open or otherwise activate a GUI screen that is the same or similar to FIG. 4 described herein. As described herein, operators can interact with a GUI screen similar to FIG. 4 to choose the manner in which the selected parameter will be changed during the uncertainty analysis described herein. The analysis option that the processor 620 will use for analyzing the corresponding parameter is displayed in box 330. Operators can enter the number of times to run the workflows or batch of workflows in simulation mode in box 340.

In some embodiments, the processor 620 can generate the ranges of different values to be used for parameters in simulated execution of workflows based on predicted uncertainties of the values, historical data, published geographical data for a region, or other data or criteria, or the processor 620 can provide possible values for these or other ranges or suggestions for ranges to the operator.

The processor 620 will perform the workflow or a simulation of the workflow an indicated number of times, for example according to the indication in box 340.

Referring again to FIG. 1, the method 100 continues at block 130 with determining predicted impacts, on the result of the oil recovery process, of changing values for the plurality of parameters. The processor 620 can determine predicted impacts by accessing a set of values to which parameters shall be set during a virtual execution of the workflow. The processor 620 can perform analysis to determine these predicted impacts using one or more analysis tools or options described herein regarding FIG. 4, although embodiments are not limited thereto.

FIG. 4 illustrates an example GUI screen 400 for selecting analysis tools the processor 620 shall use in sensitivity analysis in accordance with some embodiments. The processor 620 may provide same or similar options for uncertainty analysis. The options can include distribution options 410, variograms 420, delimited lists of values 430, or other options. Embodiments are not limited to any particular analysis type.

As will be understood by those of ordinary skill in the art, distribution options 410 quantify the extent to which a parameter will be varied during the uncertainty analysis.

A variogram 420 can inform the operator of the variability of parameter data in space. For example, some geographically-sensitive data may have variability in geographic space to the extent that, if a value for the corresponding parameter is known at a first geographic location, that value may not be accurate at a different geographical location at a distance from the first geographic location.

The variogram can indicate the probability of how different values can be for the parameter at various distances from the first geographic location where the measurement was taken. Selection of the delimited lists of values 430 option can result in a list of resulting values for parameters after one or more executions of workflows or batches of workflows.

At the end of each run of the workflow, the processor 620 will record and/or provide a report of the impact that changing different parameters will have on the result. For example, if the result is geocellular model, a layering parameter can be changed within a range, and the processor 620 can generate a geocellular model at each run of the workflow using the different values for the parameter.

The processor 620 can then display a graph or other indication or rank of the most important or influential parameter or parameters, based on the effect of those parameters on the geocellular model or other output of the workflow. A ranking can be similar to that shown in Table 1, below:

TABLE 1
Rank.

| Parameter | Rank |
|---|---|
| Layer thickness | 1 |
| Layer style | 2 |
| Horizontal gridding density | 3 |

FIG. 5 illustrates an example GUI screen 500 for selecting sensitivity analysis output options in accordance with some embodiments. The processor 620 can receive a user selection of one or more of these output options and generate a display in accordance with the selection. For example, the processor 620 can generate a tornado chart 510 of a selected parameter, an inverse cumulative distribution function (ICDF) 520, a probability distribution function (PDF) and a cumulative distribution function (CDF) 530, although embodiments are not limited thereto.

While embodiments have been described herein regarding sensitivity analysis, embodiments can also perform uncertainty analysis. In accordance with embodiments for uncertainty analysis, the processor 620 can assign or generate ranges for values of parameters according to known or predicted margins of errors or sensitivity of measurement tools 660 (FIG. 6) that have provided data to the system 600. The processor 620 can perform workflows a multiplicity of iterations with values for parameters set in the range or ranges described herein and the processor 620 can record outputs of workflows for one or more of those iterations. The processor 620 can then generate distribution functions of those recorded outputs to determine best-case scenarios for values of the outputs, worst-case scenarios for values of the outputs, or other scenarios, and the processor 620 can present these scenarios to the operator on, for example, display units 655 (FIG. 6). These embodiments, therefore, can allow operators to make decisions based on any or all of these different scenarios.

The method 100 continues at block 140 with selecting a parameter of the plurality of parameters that has a largest predicted impact on the result relative to the predicted impacts of non-selected ones of the plurality of parameters, to provide a selected parameter. In some embodiments, a selection algorithm for selecting the parameter can calculate the minimum and maximum of the output values for one parameter, while holding other parameters constant. The selection algorithm can then calculate the range of the output by subtracting the minimum from the maximum. The parameter that has the largest range will be considered the parameter with the largest impact.

The method 100 continues at block 150 with providing a recommendation for refinement of measurement data related to the selected parameter. The recommendation can include ranks such as those discussed regarding Table 1 herein. For example, the processor 620 can provide geographic coordinates or other indications of a location at which to control measurement equipment to take additional measurements of the selected parameter. The processor 620 can provide a display or other indication similar to that shown in Table 2, below:

TABLE 2
Recommendations for parameter refinement.

| Parameter | measurement location | Coordinates |
|---|---|---|
| Layer thickness | Lot 1, Section 4 | 48°24′59″N 102°19′55″W |
| Layer style | Lot 1, Section 10 | 39°51′44″N 108°19′55″W |
| Horizontal gridding | Lot 17, Section 42 | |

Embodiments described herein can allow oil and gas drilling exploration corporations to allocate resources to obtain more accurate measurements of parameters that have larger impacts on workflows based on previous measurements provided to systems 600 (FIG. 6) at an operator's offices or at other locations. Embodiments can help operators prevent allocating unnecessary resources to obtaining measurements of parameters that are unimportant or less important due to their lack of impact on workflows.

FIG. 6 depicts a block diagram of features of a system 600 in accordance with various embodiments. The system 600 can provide a recommendation for refinement of measurement data related to measured parameters as described above.

The system 600 can include a log interpretive tool 605 such as a Halliburton ShaleXpert™ available from the Halliburton Company of Houston, Tex.

The system includes a processor 620. The log interpretive tool 605 can execute on the processor 620 or on another processor (not shown in FIG. 6) of the system 600.

The system 600 can additionally include a controller 625 and a memory 635. The controller 625 can operate to provide geographic coordinates to control measurement tools 660 to obtain refined measurement data based on the geographic coordinates as described herein, or the system 600 can provide these coordinates to another system (not shown in FIG. 6) for controlling a drilling instrument or measurement instrument. The memory 635 can store workflows, workflow databases, and measurement data for one or more of the parameters related to the workflow operations. The processor 620 can access these workflows to perform any of the operations described herein. The memory 635 can additionally store configuration files for executing batch jobs of a plurality of related workflows and values to be used for each of the parameters of the list during virtual execution of the batch jobs. The memory 635 can further store data related the measurement tools 660, for example predicted error information of the measurement tools 660, although embodiments are not limited thereto.

The communications unit 640 can provide downhole communications in a drilling operation or measurement operation, although such downhole communications can also be provided by any other system located at or near drilling coordinates or measurement coordinates of a surface of the Earth where drilling or measurement will take place. Such downhole communications can include a telemetry system.

The system 600 can also include a bus 627, where the bus 627 provides electrical conductivity among the components of the system 600. The bus 627 can include an address bus, a data bus, and a control bus, each independently configured. The bus 627 can also use common conductive lines for providing one or more of address, data, or control, and the controller 625 can regulate usage of these lines. The bus 627 can include instrumentality for a communication network. The bus 627 can be configured such that the components of the system 600 are distributed. Such distribution can be arranged between downhole components and components that can be disposed on the surface of a well. Alternatively, various ones of these components can be co-located, such as on one or more collars of a drill string or on a wireline structure.

In various embodiments, the system 600 comprises peripheral devices 645 that can include displays, user input devices, additional storage memory, and control devices that may operate in conjunction with the controller 625 or the memory 635. For example, the peripheral devices 645 can include a user input device to receive user input responsive to providing the example GUI screens 200, 300, 400, and 500 described herein. The peripheral devices 645 can include a display for displaying the example GUI screens 200, 300, 400 and 500 as described herein. For example, the peripheral devices 645 or the display units 655 can be arranged to display a portion of results within a graph. The graph can include one or more of a variogram, a cumulative distribution function, an inverse cumulative distribution function, and a probability distribution function for parameters of workflows as described herein. The display units 655 or other peripheral devices 645 can also be arranged to display a ranked list of the plurality of parameters, wherein the ranked listed is ordered according to a size of the predicted impact of the parameters on the workflow.

In an embodiment, the controller 625 can be realized as one or more processors. The peripheral 645 can be programmed to operate in conjunction with display unit(s) 655 with instructions stored in the memory 635 to implement a GUI to manage the operation of components distributed within the system 600. A GUI can operate in conjunction with the communications unit 640 and the bus 627.

In various embodiments, a non-transitory machine-readable storage device can comprise instructions stored thereon, which, when performed by a machine, cause the machine to perform operations, the operations comprising one or more features similar to or identical to features of methods and techniques described herein. A machine-readable storage device, herein, is a physical device that stores data represented by physical structure within the device. Examples of machine-readable storage devices can include, but are not limited to, memory 635 in the form of read only memory (ROM), random access memory (RAM), a magnetic disk storage device, an optical storage device, a flash memory, and other electronic, magnetic, or optical memory devices, including combinations thereof.

One or more processors such as, for example, the processing unit 620, can operate on the physical structure of such instructions. Executing these instructions determined by the physical structures can cause the machine to perform operations to access a workflow, the workflow including workflow operations for performing an oil recovery process and the workflow having a result on the oil recovery process; to generate a list that includes a plurality of parameters related to the workflow operations; to determine predicted impacts, on the result, of changing values for the plurality of parameters; to select a parameter of the plurality of parameters that has a largest predicted impact on the result relative to the predicted impacts of other parameters of the plurality of parameters, to provide a selected parameter; and to provide a recommendation for refinement of measurement data related to the selected parameter.

The instructions can include instructions to cause the processing unit 620 to perform any of, or a portion of, the above-described operations in parallel with performance of any other portion of the above-described operations. The processing unit 620 can store, in memory 635, any or all of the data received from the log interpretive tool 605 or from measurement tools 660.

Although specific embodiments have been illustrated and described herein, it will be appreciated by those of ordinary skill in the art that any arrangement that is calculated to achieve the same purpose may be substituted for the specific embodiments shown. Various embodiments use permutations or combinations of embodiments described herein. It is to be understood that the above description is intended to be illustrative, and not restrictive, and that the phraseology or terminology employed herein is for the purpose of description. Combinations of the above embodiments and other embodiments will be apparent to those of ordinary skill in the art upon studying the above description.

What is claimed is:

1. A processor-implemented method comprising:
accessing a workflow database, the workflow database including operations data describing workflow operations for performing an oil recovery process and the workflow database having result data indicating a result of the oil recovery process;
generating a list that includes a plurality of parameters related to the workflow operations;
determining predicted impacts, on the result, of changing values for the plurality of parameters;
selecting a parameter of the plurality of parameters that has a largest predicted impact on the result relative to the predicted impacts of non-selected ones of the plurality of parameters, to provide a selected parameter; and
providing a recommendation for refinement of measurement data related to the selected parameter.

2. The method of claim 1, further comprising:
receiving a request to provide a visual display of values of a parameter in addition to parameters related to the workflow operations; and
generating the visual display.

3. The method of claim 1, wherein generating the list comprises:
receiving a selection of parameters from a group of parameters related to one or more workflow operations of the workflow; and
populating the list with two or more parameters of the selection of parameters, the two or more parameters in combination making up the plurality of parameters.

4. The method of claim 3, further comprising:
restricting the group of parameters available for selection based on a criterion.

5. The method of claim 4, further comprising:
determining which parameters can be selected from the group based on a property of a corresponding workflow operation.

6. The method of claim 5, further comprising:
determining which parameters shall be selectable based on a selection state of other parameters related to previous operations of the workflow.

7. The method of claim 1, wherein providing the recommendation comprises:
providing geographic coordinates of a location at which to control measurement equipment to take additional measurements of the selected parameter.

8. The method of claim 7, further comprising:
determining, based on identifying information of a previous measurement of the selected parameter, whether an additional measurement of the selected parameter is to be taken within a geographic distance of the previous measurement.

9. The method of claim 8, further comprising:
determining the geographic distance at which the additional measurement is to be taken based on a variogram report of measurements of the selected parameter.

10. The method of claim 1, wherein determining predicted impacts comprises:
accessing a set of values to which the plurality of parameters shall be set during a virtual execution of the workflow; and
recording a result of virtual execution of the workflow.

11. The method of claim 10, wherein the set of values includes a range of values, the range of values being based on a predicted uncertainty of a corresponding parameter.

12. A system comprising:
one or more processors to
access a workflow, the workflow including workflow operations for performing an oil recovery process and the workflow having a result on the oil recovery process;
generate a list that includes a plurality of parameters related to the workflow operations; and
determine predicted impacts, on the result, of changing values for the plurality of parameters;
select a parameter of the plurality of parameters that has a largest predicted impact on the result relative to the predicted impacts of other parameters of the plurality of parameters, to provide a selected parameter; and
provide a recommendation for refinement of measurement data related to the selected parameter; and
memory to store
the workflow, and
measurement data for one or more of the parameters related to the workflow operations.

13. The system of claim 12, further comprising a display to display the recommendation and to display information related to the workflow.

14. The system of claim 13, wherein the recommendation includes geographic coordinates for obtaining refined measurement data, and wherein the system further comprises a control system to receive the geographic coordinates and to control measurement equipment based on the geographic coordinates.

15. The system of claim 12, wherein the memory is further arranged to store configuration files for executing batch jobs of a plurality of related workflows, values to be used for each of the parameters of the list during virtual execution of the batch jobs, and
data related the measurement equipment.

16. The system of claim 15, wherein the data related to the measurement equipment includes predicted error information for the measurement equipment.

17. The system of claim 15, wherein the one or more processors are further arranged to:
access the values to be used for each of the parameters;
execute, virtually, one or more workflows of the batch jobs; and
record the result of executing the workflow using the sets of values for each of the parameters.

18. The system of claim 17, wherein the display is further arranged to display a portion of the result within a graph including one or more of a variogram, a cumulative distribution function, an inverse cumulative distribution function, and a probability distribution function for a parameter of the plurality of parameters.

19. The system of claim 18, wherein the display is further arranged to display a ranked list of the plurality of parameters, wherein the ranked listed is ordered according to a size of the predicted impact.

20. A non-transitory machine-readable storage device having instructions stored thereon which, when performed by a machine, cause the machine to perform operations, the operations comprising:
accessing a workflow, the workflow including workflow operations for performing an oil recovery process and the workflow having a result on the oil recovery process;
generating a list that includes a plurality of parameters related to the workflow operations;
determining predicted impacts, on the result, of changing values for the plurality of parameters;
selecting a parameter of the plurality of parameters that has a largest predicted impact on the result relative to the predicted impacts of other parameters of the plurality of parameters, to provide a selected parameter; and
providing a recommendation for refinement of measurement data related to the selected parameter.

21. The non-transitory machine-readable storage device of claim 20 wherein the instructions, when accessed, result in the machine:
accessing information for a batch job including a plurality of workflows;
accessing values to be used for parameters in the list when executing the batch job of workflows; and
generating a display of the result of executing one or more workflows of the batch job.

22. The non-transitory machine-readable storage device of claim 21 wherein the instructions, when accessed, result in the machine:
ranking the parameters in the list according to a size of the predicted impact on the result generated by changing values of the parameters, to provide a parameter rank; and
publishing the parameter rank on the display.

23. The non-transitory machine-readable storage device of claim 20, wherein the instructions, when accessed, resulting in the machine:
providing first geographic coordinates of a location at which to control measurement equipment to take additional measurements of the selected parameter for refinement of the measurement data; and
accessing variogram information for previous measurements of the selected parameter taken by the measurement equipment to determine a geographic distance, from the first geographic coordinates, at which to take measurements of the selected parameter.
